(19) United States
(12) Patent Application Publication
(10) Pub. No.: US 2009/0002643 A1
(43) Pub. Date: Jan. 1, 2009

(54) Shaped Mirror on a Projection Ray Path for Display Instruments

(76) Inventor: Michel Alain Cadio, Carmel, IN (US)

Correspondence Address: Joseph J. Laks;Thomson Licensing LLC, 2 Independence Way, Patent Operations, PO Box 5312, PRINCETON, NJ, 08543, US

(21) Appl. No.: 12/087,353

(22) PCT Filed: Jan. 6, 2006
(86) PCT No.: PCT/US2006/000515

§ 371 Date: Jul. 2, 2008

(51) Int. Cl. G03B 21/28

(52) U.S. Cl. 353/69; 353/98

(57) ABSTRACT

A projection display having a projection path through a shaped mirror positioned perpendicular with the screen. The shaped mirror positioned on a projection path reduces the depth of the projection display while eliminating image distortion at the center of the screen.

### BACKGROUND OF THE INVENTION

1. Field of the Invention

The invention relates generally to a projection display and, in particular to the projection ray path in a projection display.

2. Description of the Background Art

Some new projection televisions include a light engine that is mounted in the cabinet below the screen in order to reduce the depth of such projection televisions. These reduced depth projection televisions position the light engines with a steep “upangle” for their ray paths. Unfortunately, such a steep “upangle” is not compatible with flat mirrors that are available for projecting steeply “upangled” ray paths onto a projection screen. These flat mirrors would in effect require larger depths for the projection television rather than to reduce them.

A need exists for projecting steeply “upangled” ray paths onto a projection screen of a projection television.

### SUMMARY OF THE INVENTION

The present invention relates to a projection display having a projection path through a shaped mirror positioned perpendicular with the screen. The shaped mirror positioned on a projection path reduces the depth of the projection display while eliminating image distortion at the center of the screen.

### BRIEF DESCRIPTION OF THE DRAWINGS

The invention will now be described in greater detail, with relation to the accompanying drawings, in which

FIG. 1 shows a prior art projection display;

FIG. 2 depicts a projection display of the present invention having a centered projection path through a shaped mirror positioned perpendicular and centered with a screen; and

FIG. 3 illustrates a rear view of the projection display of the present invention.

### DETAILED DESCRIPTION

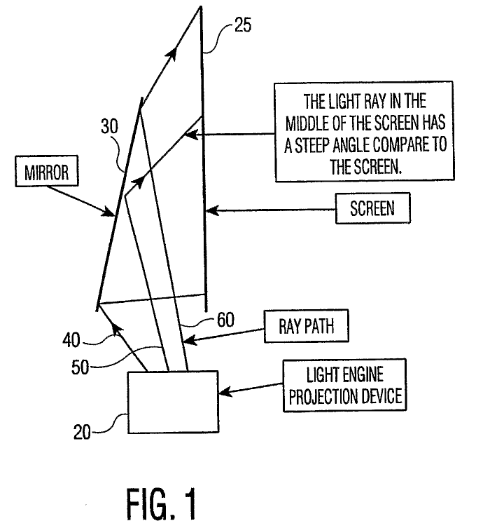

As shown in FIG. 1, an existing projection display comprises a cabinet (not shown) that is formed from a molded plastic and surrounds a light box 20, a flat mirror 30 and a screen 25. An image from the light box is directed onto the flat mirror 30 and then reflected onto the screen 25. In FIG. 1 several ray paths 40, 50, 60 illustrate how the light is directed on different regions of the mirror 30 and reflected onto the screen 25. Light directed along ray paths 40, 50, in the middle and top of the screen have a steep angle compared to the screen 25.

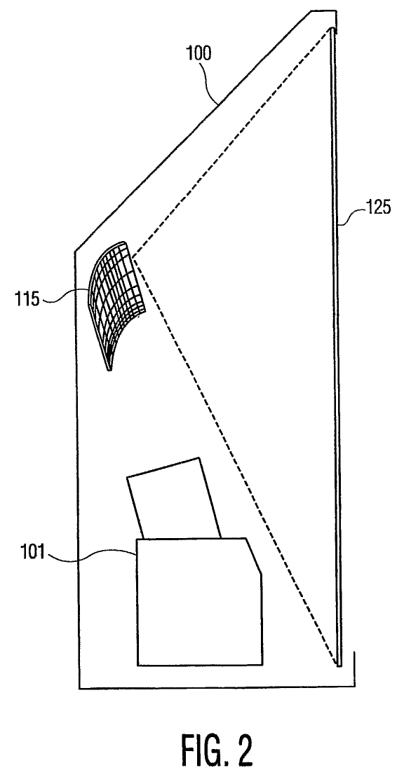

The present invention, shown in FIG. 2 includes a television cabinet 100 having a light engine 101, a shaped mirror 115 and a screen 125. The image ray path from the light engine is directed to the shaped mirror 115 that is positioned on a line or close to a line that is perpendicular to the screen 125.

The shaped mirror 115 bends the light from the light engine 101 towards the screen 125 which is perpendicular to the shaped mirror 115. The shaped mirror 115 matches each point of image provided by the light engine 101 to the corresponding point on the display screen 125. Referring to FIG. 2, the shaped mirror 115 advantageously permits use of screens 125 having a height that is about the same as the height of the display cabinet 100. Using the shaped mirror also eliminates the issue of image distortion seen when the light comes at a small angle with respect to the center of the screen, while reducing the depth of the display apparatus.

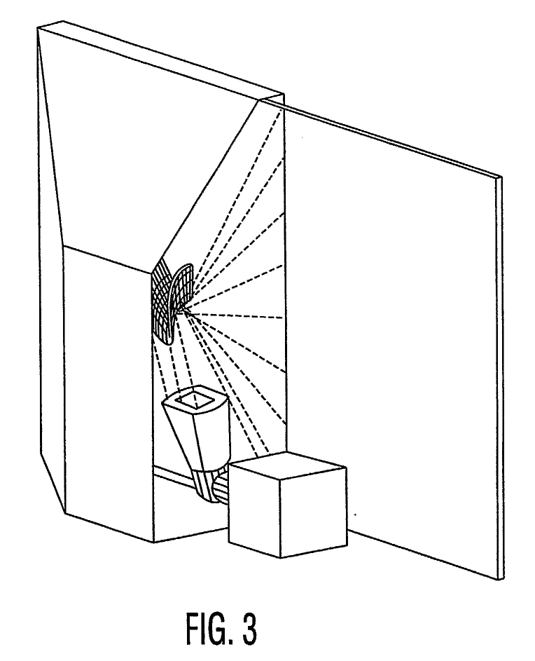

In FIG. 2 the shaped mirror has a convex contour. Other contours are also contemplated for the shaped mirror as long as its shape matches each point of image provided by the light engine to the corresponding point on the display screen, as shown in FIG. 3.

Although an exemplary projection display which incorporates the teachings of the present invention has been shown and described in detail herein, those skilled in the art can readily devise many other varied embodiments that still incorporate these teachings.

1. A projection display, comprising:
a light engine;
a shaped mirror positioned at the output of the light engine; and
a screen, wherein the shaped mirror is positioned perpendicular to the screen.

2. The projection display of claim 1 wherein the shaped mirror is positioned to reduce distortion in the center point of the screen.

3. The projection display of claim 1 wherein the shaped mirror has a convex shape.

4. The projection display of claim 3 wherein the shaped mirror is positioned convex towards the screen.

5. A projection system, comprising:
a light engine;
a shaped mirror positioned at the output of the light engine; and
a screen, wherein the shaped mirror is positioned perpendicular to the screen.

6. The projection system of claim 5 wherein the shaped mirror is positioned to reduce distortion in the center point of the screen.

7. The projection system of claim 5 wherein the shaped mirror has a convex shape.

8. The projection system of claim 7 wherein the shaped mirror is positioned convex towards the screen.
